(19) United States
(12) Patent Application Publication
(10) Pub. No.: US 2008/0152793 A1
(43) Pub. Date: Jun. 26, 2008

(54) METHOD FOR THE DEPOSITION OF A RUTHENIUM CONTAINING FILM WITH ARYL AND DIENE CONTAINING COMPLEXES

(75) Inventors: Julien Gatineau, Tsukuba-Shi (JP); Christian Dussarrat, Tsukuba-Shi (JP)

Correspondence Address: AIR LIQUIDE;Intellectual Property, 2700 POST OAK BOULEVARD, SUITE 1800, HOUSTON, TX, 77056, US

(73) Assignee: L'Air Liquide, Societe Anonyme pour l'Etude et l'Exploitaion des Procedes Georges Claude

(21) Appl. No.: 11/830,973

(22) Filed: Jul. 31, 2007

Related U.S. Application Data
(60) Provisional application No. 60/871,477, filed on Dec. 22, 2006.

(51) Int. Cl. B05D 5/12; C07F 15/00

(52) U.S. Cl. 427/126.1; 556/136

(57) ABSTRACT

Novel ruthenium precursors having melting points no more than about 50° C. are described herein. The disclosed ruthenium precursors may be liquids at 25° C., which enables their use without addition of a solvent and also eliminating a source of impurities. Pure ruthenium films or ruthenium containing films depending on the co-reactant used with the precursors may be obtained without detectable incubation time. Besides CVD, an ALD regime may be obtained for pure ruthenium deposition as well as for deposition of other ruthenium containing films (SrRuO₃, RuO₂ for example).

### CROSS-REFERENCE TO RELATED APPLICATIONS

The present application claims the benefit of U.S. Provisional Application Ser. No. 60/871,477 filed Dec. 22, 2006, herein incorporated by reference in its entirety for all purposes.

### BACKGROUND

1. Field of the Invention

This invention relates generally to the field of semiconductor film deposition. More specifically, the invention relates to compositions and methods for semiconductor film deposition.

2. Background of the Invention

Ruthenium (Ru) is expected to be introduced in the industrial semiconductor manufacturing process for many applications in the coming years. This move towards the use of new materials for chip manufacturing is necessary to solve issues generated by the continuous scaling trend imposed to the industry. For the next generation nodes, Ru is considered as the best candidate for the electrode capacitor for FeRAM and DRAM applications. Ru has the required properties, such as high melting point, low resistivity, high oxidation resistance and adequate work function, making it a potential gate electrode material for CMOS transistors. Ru has advantages compared to iridium and platinum due to its lower resistivity and ease of dry etching. Additionally, RuO₂ has a high conductivity so the formation of Ru oxide by diffusion of oxygen, that could come from ferroelectric films (PZT, SBT, BLT, . . . ), will have less impact on electrical properties than other metal oxides known to be more insulating.

Ru is also a promising BEOL process candidate as a glue layer or seed-layer material for copper. The deposition of a ruthenium film on a Ta-based material (TaN), used as an oxygen barrier layer, in CVD or ALD mode enables to directly deposit copper on it without using the actual heavy preparation or to enhance the adhesion between the tantalum-containing layers and the copper lines.

A large variety of Ru CVD precursors are available and many have been studied in CVD (Chemical Vapor Deposition) or ALD (Atomic Layer Deposition). However, the currently available precursors have some drawbacks such as low vapor pressure (i.e. 0.1 Torr at 73° C. for Ru(EtCp)₂) and high impurity content (carbon and oxygen in most of the cases) in the resulting films. The C impurities may originate from the precursor material. The O impurity may come from the co-reactant gas (O₂). Ru films have been shown to have poor adherence, uniformity and also have a characteristically long incubation time. The incubation time is defined by the difference time between the moment when the gas is flown in the reaction furnace and the moment when the deposition of a film actually starts.

Ru precursors such as tricarbonyl (1,3-cyclohexadiene) Ru precursor have been used to deposit rough ruthenium oxide layers, where the particular precursor is held in a bubbler reservoir at room temperature (about 25° C.) and helium is bubbled through it. However, Ru(CO)₃(1,3-cyclohexadiene) is not liquid at room temperature (it melts at about 35° C.) and it is necessary to dissolve such precursor in a solvent in order to obtain a liquid solution of precursor and solvent through which the inert gas such as helium is bubbled.

All the known precursors of Ru containing a CO molecule have essentially the same drawback which is their high melting point. A solvent is generally necessary to obtain a liquid product that will allow the vaporized precursor to flow more easily into the reaction furnace by regular liquid delivery methods (bubbling or vaporization are usual examples of such delivery techniques). However, the use of a solvent is usually viewed as having a bad influence on the deposition process due to the intrusion of the solvent molecules in the reactor and the incorporation of undesired impurities in the deposited films. Moreover, the solvents used are usually toxic and/or flammable and their usage brings many constraints (safety aspects, environmental issues).

The use of precursors with melting points higher than 20° C. (and even for those having a melting point above 0° C.) causes many additional constraints during the deposition process (e.g. heating of the delivery lines to avoid condensation of the precursor at undesired locations) and during transportation of the precursors. The reactivity of the known CO containing precursors does not enable implementation of such precursors in an ALD deposition regime. Ruthenium films are typically deposited by CVD and some articles even outline that ALD mode is not possible with the Ru(CO)₃(1,3-cyclohexadiene) precursor.

Consequently, there is a need for a ruthenium precursor with a low melting point capable of being used in an ALD deposition process.

### BRIEF SUMMARY

Novel ruthenium precursors having melting points no more than about 50° C. are described herein. The disclosed ruthenium precursors may be maintained as pure liquids without the addition of a solvent or a mixture of solvents, which enables the deposition of pure ruthenium films or ruthenium containing films depending on the co-reactant used with the precursors in which the resulting films are deposited without detectable incubation time, and for which a CVD and ALD regime can be obtained for pure ruthenium deposition as well as for deposition of other ruthenium containing films (SrRuO₃, RuO₂ for example).

In an embodiment, a precursor for semiconductor film deposition comprises a ruthenium complex having the following formula:

(L¹)ₓRu(L²)

where L¹ comprises a 1,3-cyclohexadiene, a 1,4-cyclohexadiene, or an acyclic alkene. The subscript x is an integer ranging from 1 to 2 and L² may comprise an aromatic ligand. Furthermore, if L² comprises an unsubstituted aromatic ligand, then L¹ comprises a substituted 1,3-cyclohexadiene, an unsubstituted or substituted 1,4-cyclohexadiene, or a substituted alkene group. In addition, if L² comprises a substituted aromatic ligand, then L¹ comprises a substituted or unsubstituted cyclohexadiene, or a substituted or unsubstituted vinyl group.

In another embodiment, a method of making a precursor for semiconductor film deposition comprises providing an aromatic-ruthenium complex. The method also comprises reacting a cyclohexadiene or an acyclic alkene with the aromatic-ruthenium complex to form the precursor.

In a further embodiment, a method for the deposition of a ruthenium film comprises placing at least one substrate into a reactor. The method also comprises introducing at least one ruthenium precursor into the reactor, said precursor having the formula:

(L¹)ₓRu(L²)

where L¹ comprises a 1,3-cyclohexadiene, a 1,4-cyclohexadiene, or an acyclic alkene. The subscript x is an integer ranging from 1 to 2 and L² may comprise an aromatic ligand. Furthermore, if L² comprises an unsubstituted benzene ligand, then L¹ comprises a substituted 1,4-cyclohexadiene, an unsubstituted or substituted 1,3-cyclohexadiene, or a substituted alkene group. In addition, if L² comprises a substituted aromatic ligand, then L¹ comprises a substituted or unsubstituted cyclohexadiene, or a substituted or unsubstituted vinyl group. Furthermore, the method comprises heating the ruthenium precursor and depositing the ruthenium film on the substrate.

In additional embodiments, the method may further comprise introducing the ruthenium precursor with or without co-reactants to a substrate to deposit a ruthenium film on the substrate. The co-reactants may be introduced simultaneously or serially with the ruthenium precursor.

The foregoing has outlined rather broadly the features and technical advantages of the present invention in order that the detailed description of the invention that follows may be better understood. Additional features and advantages of the invention will be described hereinafter that form the subject of the claims of the invention. It should be appreciated by those skilled in the art that the conception and the specific embodiments disclosed may be readily utilized as a basis for modifying or designing other structures for carrying out the same purposes of the present invention. It should also be realized by those skilled in the art that such equivalent constructions do not depart from the spirit and scope of the invention as set forth in the appended claims.

### BRIEF DESCRIPTION OF THE DRAWINGS

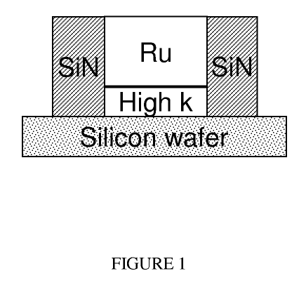

For a detailed description of the preferred embodiments of the invention, reference will now be made to the accompanying drawings in which FIG. 1 illustrates an exemplary complementary metal-oxide-semiconductor (CMOS) structure with a deposited ruthenium layer;

### NOTATION AND NOMENCLATURE

Certain terms are used throughout the following description and claims to refer to particular system components. This document does not intend to distinguish between components that differ in name but not function.

In the following discussion and in the claims, the terms “including” and “comprising” are used in an open-ended fashion, and thus should be interpreted to mean “including, but not limited to . . . ”.

### DETAILED DESCRIPTION OF THE PREFERRED EMBODIMENTS

In embodiments, a semiconductor film deposition precursor comprises a ruthenium atom coupled to at least a first and second ligand. The first and second ligands are preferably different from each other. In embodiments, the first ligand is a two to four electron donor ligand whereas the second ligand is a six electron donor ligand. More particularly, the precursor comprises a ruthenium complex having the following formula:

(L¹)ₓRu(L²)

where L¹ may be a 1,3-cyclohexadiene, a 1,4-cyclohexadiene, or an acyclic alkene, x is an integer ranging from 1 to 2, and L² may be an aromatic ligand. If L² comprises an unsubstituted aromatic ligand, L¹ comprises a substituted 1,3-cyclohexadiene, an unsubstituted or substituted 1,4-cyclohexadiene or a substituted acyclic alkene. However, when L² comprises a substituted aromatic ligand, then L¹ may be either substituted or unsubstituted. As used herein, “substituted” or “unsubstituted” may refer to the presence or absence, respectively of functional groups coupled to the ligand. A “substituent” refers to a functional group coupled to the base ligand. In addition, an “unsubstituted aromatic ligand” refers to an unsubstituted benzene ligand. The term “acyclic” may describe any ligand that is branched or unbranched, and does not form a closed ring.

Generally, either L¹ or L² comprises at least one substituent. In some cases, both ligands may have substituents. Without being limited by theory, it is believed that the addition of substituents on the first and/or second ligands may optimize the steric hindrance and the reduction of electronic interaction between the ligands. These effects may help to decrease the melting point of the novel precursors.

In an embodiment, L¹ is a 1,4-cyclohexadiene ligand. The 1,4-cyclohexadiene may have the following formula:

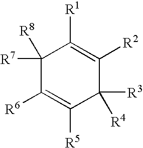

Where R¹-R⁸ may each independently be hydrogen, an alkyl group, an alkylamide group, an alkoxide, an alkylsilyamide, an amidinate, a carbonyl group, or combinations thereof. The alkyl group may be branched or unbranched. In addition, the alkyl group may be saturated or unsaturated. In embodiments, the alkyl group may contain from 1 to 10 carbon atoms. R¹-R⁸ may be the same or different from one another. In one embodiment, R¹-R⁸ are all hydrogen. That is, the 1,4-cyclohexadiene ligand is unsubstituted.

In another embodiment, L¹ is a 1,3-cyclohexadiene ligand having the following formula:

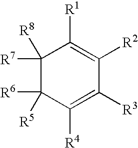

where R¹-R⁸ may each independently be hydrogen, an alkyl group, an alkylamide group, an alkoxide, an alkylsilyamide, an amidinate, a carbonyl group, or combinations thereof. The alkyl group may be branched or unbranched. In addition, the alkyl group may be saturated or unsaturated. In embodiments, the alkyl group may contain from 1 to 10 carbon atoms. R¹-R⁸ may be the same or different from one another.

In further embodiments, examples of suitable L¹ ligands include without limitation, 1,4-cyclohexadiene, 1-methyl-1,3-cyclohexadiene, 2-methyl-1,3-cyclohexadiene, 5-methyl-1,3-cyclohexadiene, 1-methyl-1,4-cyclohexadiene, 3-methyl-1,4-cyclohexadiene, 1-ethyl-1,3-cyclohexadiene, 2-ethyl-1,3-cyclohexadiene, 5-ethyl-1,3-cyclohexadiene, 1-ethyl-1,4-cyclohexadiene, or 3-ethyl-1,4-cyclohexadiene.

In other embodiments, L¹ may be any suitable acyclic alkene group such as without limitations, dienes, trienes, olefins, ethylene, propylene, butylene, etc. However, in one embodiment, L¹ may comprise an acyclic alkene group having the formula:

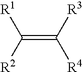

where R¹-R⁴ may each independently be hydrogen, an alkyl group, an alkylamide group, an alkoxide, an alkylsilyamide, an amidinate, a carbonyl group, or combinations thereof. The alkyl group may be branched or unbranched. In addition, the alkyl group may be saturated or unsaturated. In embodiments, the alkyl group may contain from 1 to 4 carbon atoms. R¹-R⁴ may be the same or different from one another.

In yet another embodiment, L¹ may comprise an acyclic alkene group having the formula:

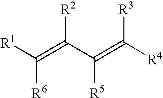

where R¹-R⁶ may each independently be hydrogen, an alkyl group, an alkylamide group, an alkoxide, an alkylsilyamide, an amidinate, a carbonyl group, or combinations thereof. The alkyl group may be branched or unbranched. In addition, the alkyl group may be saturated or unsaturated. In embodiments, the alkyl group may contain from 1 to 4 carbon atoms. R¹-R⁴ may be the same or different from one another.

In one of the embodiments, L² is an aromatic or phenyl ligand having the formula:

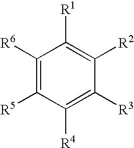

where R¹-R⁶ may independently be hydrogen, an alkyl group, an alkylamide group, an alkoxide, an alkylsilyamide, an amidinate, a carbonyl group, or combinations thereof. The alkyl group may be branched or unbranched. In addition, the alkyl group may be saturated or unsaturated. In embodiments, the alkyl group may contain from 1 to 10 carbon atoms. Examples of aromatic ligands include without limitation, benzene, xylene, mesitylene, aniline, ethylbenzene, other alkylbenzenes, styrene, toluene, and the like. R¹-R⁶ may be the same or different from one another.

Examples of precursors include without limitation, Ru(benzene)(1,4-cyclohexadiene), Ru(benzene)(1-methyl-1,3-cyclohexadiene), Ru(benzene)(2-methyl-1,3-cyclohexadiene), Ru(benzene)(5-methyl-1,3-cyclohexadiene), Ru(benzene)(1-methyl-1,4-cyclohexadiene), Ru(benzene)(3-methyl-1,4-cyclohexadiene), Ru(toluene)(1,3-cyclohexadiene), Ru(toluene)(1-methyl-1,3-cyclohexadiene), Ru(toluene)(2-methyl-1,3-cyclohexadiene), Ru(toluene)(5-methyl-1,3-cyclohexadiene), Ru(toluene)(1,4-cyclohexadiene), Ru(toluene)(1-methyl-1,4-cyclohexadiene), Ru(toluene)(3-methyl-1,4-cyclohexadiene), Ru(xylene)(1,3-cyclohexadiene), Ru(xylene)(1-methyl-1,3-cyclohexadiene), Ru(xylene)(2-methyl-1,3-cyclohexadiene), Ru(xylene)(5-methyl-1,3-cyclohexadiene), Ru(xylene)(1,4-cyclohexadiene), Ru(xylene)(1-methyl-1,4-cyclohexadiene), Ru(xylene)(3-methyl-1,4-cyclohexadiene), Ru(mesitylene)(1,3-cyclohexadiene), Ru(mesitylene)(1-methyl-1,3-cyclohexadiene), Ru(mesitylene)(2-methyl-1,3-cyclohexadiene), Ru(mesitylene)(5-methyl-1,3-cyclohexadiene), Ru(mesitylene)(1,4-cyclohexadiene), Ru(mesitylene)(1-methyl-1,4-cyclohexadiene), Ru(mesitylene)(3-methyl-1,4-cyclohexadiene), Ru(benzene)(1-ethyl-1,3-cyclohexadiene), Ru(benzene)(2-ethyl-1,3-cyclohexadiene), Ru(benzene)(5-ethyl-1,3-cyclohexadiene), Ru(benzene)(1-ethyl-1,4-cyclohexadiene), Ru(benzene)(3-ethyl-1,4-cyclohexadiene), Ru(toluene)(1-ethyl-1,3-cyclohexadiene), Ru(toluene)(2-ethyl-1,3-cyclohexadiene), Ru(toluene)(5-ethyl-1,3-cyclohexadiene), Ru(toluene)(1-ethyl-1,4-cyclohexadiene), Ru(toluene)(3-ethyl-1,4-cyclohexadiene), Ru(xylene)(1-ethyl-1,3-cyclohexadiene), Ru(xylene)(2-ethyl-1,3-cyclohexadiene), Ru(xylene)(5-ethyl-1,3-cyclohexadiene), Ru(xylene)(1-ethyl-1,4-cyclohexadiene), Ru(xylene)(3-ethyl-1,4-cyclohexadiene), Ru(mesitylene)(1-ethyl-1,3-cyclohexadiene), Ru(mesitylene)(2-ethyl-1,3-cyclohexadiene), Ru(mesitylene)(5-ethyl-1,3-cyclohexadiene), Ru(mesitylene)(1-ethyl-1,4-cyclohexadiene), Ru(mesitylene)(3-ethyl-1,4-cyclohexadiene), and mixtures thereof.

In various embodiments, the precursors disclosed herein may have a melting point below about 50° C., preferably below about 25° C., more preferably they are liquid at temperatures below 0° C. Low melting temperatures are desirable in order to prevent the precursor from solidifying during transportation of the precursors.

In an embodiment, a method of preparing a semiconductor film precursor comprises forming or providing a ruthenium-aromatic complex. The ruthenium-aromatic complex may be formed by the reaction of an aromatic ligand, as described above, with RuCl₃-nH₂O to form a dimer. Examples of suitable aromatic compounds include without limitation, toluene, benzene, mesitylene, xylene, ethylbenzene, and the like. For example, toluene may be reacted with RuCl₃-nH₂O in ethanol to give the dimer, [(toluene)RuCl₂]₂. The dimer is mixed with the desired L¹ ligand to give the final product (toluene)Ru(L¹) or (toluene)Ru(L¹)₂. In another embodiment, the desired ligand, L¹, is reacted with [(benzene)RuCl₂]₂ in order to get the final product (benzene)Ru(L¹), or (benzene)Ru(L¹)₂.

In an embodiment, a method of preparing a semiconductor film precursor comprises reacting a cyclohexadiene or an acyclic alkene ligand with a ruthenium-aromatic ligand. The cyclohexadiene may be substituted or unsubstituted. Examples of suitable cyclohexadienes are substituted cyclohexadienes such as without limitation, methyl-1,4-cyclohexadienes, ethyl-1,4-cyclohexadienes, methyl-1,3-cyclohexadienes, ethyl-1,3-cyclohexadienes, other alkyl cyclohexadienes, or combinations thereof. The cyclohexadiene may be any of the cyclohexadienes disclosed with respect to the ligand L₁, as described above. For example, Ru(toluene)(1-methyl-1,4-cyclohexadiene) could be synthesized by reacting 1-methyl-1,4-cyclohexadiene with RuCl₃ in refluxing ethanol to form [(toluene)Ru(II)Cl₂]₂. This complex is reacted and reduced with 1-methyl-1,4-cyclohexadiene and the target compound is formed.

Like the cyclohexadiene, the alkene may be substituted or unsubstituted. Examples of suitable alkenes include without limitation, ethylene, butylene, propylene, pentene, hexene, heptene, other olefins, butadiene, dienes, trienes, and the like. As with the cyclohexadiene, the alkene may be any alkene recited with respect to the ligand L₁ described above.

The disclosed precursors may be used in any suitable deposition processes known to those of skill in the art. In one embodiment, the disclosed precursors are used in an atomic layer deposition (ALD) process. ALD is a deposition technique that is widely used for its capability of depositing uniform and conformal thin films. ALD involves separately introducing the reactants in the reaction furnace, each introduction step being separated by a purge of the reaction furnace by an inert gas mixture. For instance, a ruthenium deposition in ALD mode can comprise a period of purge, which is followed by the introduction the vaporized ruthenium precursor into a reactor comprising a substrate. As used herein, a substrate may refer to any layer or material commonly used in semiconductor fabrication (e.g. silicon wafers, silicon oxide materials, germanium materials, and other semiconducting materials known in the art). Unlike a basic chemical vapor deposition (CVD) process, the precursor reacts with the surface of the substrate. The vapors of the precursor will uniformly adsorb on the substrate and a layer of approximately one atom is formed. Once the surface of the substrate is completely covered and the layer or film is formed, additional ruthenium atoms cannot adsorb onto the surface of the substrate anymore. This property is called the self-limiting property of ALD. Then, an inert gas may be flowed into the reaction furnace in order to get rid of the un-reacted precursor molecules and all the generated by-products. In certain embodiments, a co-reactant may be introduced in order to react with the previously deposited layer, ultimately resulting with a ruthenium film being deposited on the substrate. This 4 step process may be called a cycle and can be repeated as needed until the ruthenium film reaches the targeted thickness, knowing that in an ideal ALD regime, 1 cycle enables to deposit a layer of 1 atom of ruthenium.

In an embodiment, the disclosed ruthenium precursors are used for the atomic layer deposition of ruthenium films in conjunction with an appropriate co-reactant. The co-reactants may be introduced simultaneously or sequentially with the disclosed ruthenium precursors. Examples of appropriate co-reactant include without limitation, molecular and atomic hydrogen, as well as ammonia and related radicals NH₂, NH, and other reductants and oxidants. The ALD process may take place at temperature ranging from about 50° C. to about 650° C., preferably from about 100° C. to about 350° C. The pressure into the reactor may be maintained between about 1 Pa and about 10⁵ Pa, preferably between 25 Pa and 10³ Pa.

In an additional embodiment, a reducing agent may be introduced into the reactor. The reducing agent may comprise a compound such as without limitation, H₂, NH₃, SiH₄, Si₂H₆, Si₃H₈, or hydrogen-containing radicals. Furthermore, an oxidizing agent such as an oxygen-containing fluid may be introduced into the reactor. The oxygen containing fluid may be without limitation, O₂, O₃, H₂O, H₂O₂, oxygen-containing radicals such as O. or OH. and mixtures thereof. The oxidizing agent and/or the reducing agent may be continuously introduced into the reactor. In addition, the oxidizing agent and/or reducing agent may be introduced simultaneously or sequentially with the disclosed ruthenium precursors. Any type of reactor known to those of skill in the art may be used with the disclosed precursors and/or co-reactants including without limitation, a cold-wall type reactor, a hot-wall type reactor, a single-wafer reactor, a multi-wafer reactor, or other types of deposition systems.

In another embodiment, the disclosed precursors may be used in a CVD process. The precursors may be used in any number of known CVD processes, which may be modified by altering such variables as, for example, the heating method, gas pressure, and/or chemical reaction. Conventional CVD methods suitable for use with the Ru precursors of the present invention include cold-wall type reactors, wherein only a deposition substrate is heated through any number of methods such as induction heating or use of hot stages. Alternatively, hot-wall type reactors, in which an entire reaction chamber is heated, can be used. In another embodiment, the CVD process may be a pulsed CVD process where the ruthenium precursor may be sequentially introduced into the reactor. The CVD processes can also vary with respect to pressure requirements and may include atmospheric CVD, in which the reaction occurs at a pressure of about one atmosphere, or low-pressure CVD, in which reaction occurs at pressures between about 10⁻¹ and about 100 torr. Various other conventional CVD methods may be utilized to form ruthenium-containing films with the described precurors. For example, plasma- or photo-assisted CVD, wherein the energy from a plasma or a light source, respectively, can be used to activate the precursor to allow depositions of Ru at reduced substrate temperatures. Alternatively, ion-beam or electron-beam assisted CVD, in which the energy from an ion or electron beam is directed toward the substrate to provide the energy for decomposition of the Ru precursor. Yet another alternative includes a laser-assisted CVD process, wherein laser light is used to heat the substrate and to effect photolytic reactions in the Ru precursor.

To further illustrate various illustrative embodiments of the present invention, the following examples are provided.

### EXAMPLE

### Deposition of Pure Ruthenium Films

Ru(1-methyl-cyclohexa-1,4-diene)(toluene) is a light yellow precursor which is liquid at 20° C. Pure ruthenium films were deposited from temperatures above 150° C. using (1-methyl-cyclohexa-1,4-diene)(toluene) ruthenium. The liquid precursor was stored in a bubbler and the vapors were delivered to a hot-wall reactor by a bubbling method. An inert gas, helium in this case, was used as a carrier gas, as well as for dilution purpose. Tests were done with and without hydrogen as co-reactant, in CVD and ALD modes.

With the conditions of our set-up, films were deposited from 150° C., at 0.5 Torr, and the deposition rate reached a plateau at 250° C. Depositions were done on silicon oxide, which served as a representative of oxide materials (gate dielectrics, capacitors . . . ) in order to validate the use of the ruthenium precursor as a viable mean for ruthenium films to be used for metal electrode (FIG. 1) (MIM, DRAM, gate electrode, . . . ).

The concentration of various elements into the ruthenium films were analyzed by an Auger spectrometer. Pure ruthenium films were deposited onto a thermal silicon dioxide layer (chosen for the same reason than above-mentioned). The concentration of oxygen in the ruthenium film was below the detection limit of AES.

### Deposition of Ruthenium Oxide Films

Ruthenium oxide films were deposited by reacting the ruthenium precursor and an oxygen containing fluid in a deposition furnace. In this particular case, the oxygen containing fluid was oxygen. It was found that ruthenium oxide depositions in ALD technique were possible when the co-reactant was molecular and atomic oxygen, as well as moisture vapors or any other oxygen containing mixture.

While embodiments of the invention have been shown and described, modifications thereof can be made by one skilled in the art without departing from the spirit and teachings of the invention. The embodiments described and the examples provided herein are exemplary only, and are not intended to be limiting. Many variations and modifications of the invention disclosed herein are possible and are within the scope of the invention. Accordingly, the scope of protection is not limited by the description set out above, but is only limited by the claims which follow, that scope including all equivalents of the subject matter of the claims.

The discussion of any reference in the Background is not an admission that such references are prior art to the subject matter of this disclosure, especially any reference that may have a publication date after the priority date of this application. The disclosures of all patents, patent applications, and publications cited herein are hereby incorporated herein by reference in their entirety, to the extent that they provide exemplary, procedural, or other details supplementary to those set forth herein.

What is claimed is:

1. A precursor for semiconductor film deposition comprising a ruthenium complex having the following formula:
(L¹)ₓRu(L²)
wherein L¹ comprises a 1,3-cyclohexadiene, a 1,4-cyclohexadiene, or an acyclic alkene, x is an integer ranging from 1 to 2, and L² comprises an aromatic ligand,
wherein if L² comprises an unsubstituted aromatic ligand, then L¹ comprises a substituted 1,3-cyclohexadiene, an unsubstituted or substituted 1,4-cyclohexadiene, or a substituted alkene group, and wherein if L² comprises a substituted aromatic ligand, then L¹ comprises a substituted or unsubstituted cyclohexadiene, or a substituted or unsubstituted acyclic alkene.

2. The precursor of claim 1 wherein said 1,4-cyclohexadiene has the following formula: 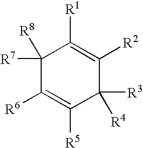
wherein R¹-R⁸ may each independently be hydrogen, an alkyl group, an alkylamide group, an alkoxide, an alkylsilyamide, an amidinate, a carbonyl group, or combinations thereof, and wherein R¹-R⁸ may be the same or different from one another.

3. The precursor of claim 1 wherein said 1,3-cyclohexadiene has the following formula: 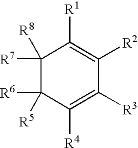
wherein R¹-R⁸ may each independently be hydrogen, an alkyl group, an alkylamide group, an alkoxide, an alkylsilyamide, an amidinate, a carbonyl group, or combinations thereof, and wherein R¹-R⁸ may be the same or different from one another.

4. The precursor of claim 1 wherein said acyclic alkene has the following formula: 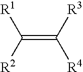
wherein R¹-R⁴ may each independently be hydrogen, an alkyl group, an alkylamide group, an alkoxide, an alkylsilyamide, an amidinate, a carbonyl group, or combinations thereof, and wherein R¹-R⁴ may be the same or different from one another.

5. The precursor of claim 1 wherein said acyclic alkene has the following formula: 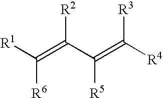
where R¹-R⁶ may each independently be hydrogen, an alkyl group, an alkylamide group, an alkoxide, an alkylsilyamide, an amidinate, a carbonyl group, or combinations thereof, and wherein R¹-R⁶ may be the same or different from one another.

6. The precursor of claim 1 wherein said aromatic ligand has the following formula: 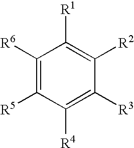
where R¹-R⁶ may independently be hydrogen, an alkyl group, an alkylamide group, an alkoxide, an alkylsilyamide, an amidinate, a carbonyl group, or combinations thereof, and wherein R¹-R⁶ may be the same or different from one another.

7. The precursor of claim 1 wherein L¹ comprises 1,3-cyclohexadiene, 1,4-cyclohexadiene, 1-methyl-1,3-cyclohexadiene, 2-methyl-1,3-cyclohexadiene, 5-methyl-1,3-cyclohexadiene, 1-methyl-1,4-cyclohexadiene, 3-methyl-1,4-cyclohexadiene, 1-ethyl-1,3-cyclohexadiene, 2-ethyl-1,3-cyclohexadiene, 5-ethyl-1,3-cyclohexadiene, 1-ethyl-1,4-cyclohexadiene, or 3-ethyl-1,4-cyclohexadiene

8. The precursor of claim 1 wherein L¹ comprises an ethylene, a butylene, a propylene, a hexane, a pentene, an olefin, a butadiene, a triene, a diene, or an alkyl butadiene.

9. The precursor of claim 1 wherein the aromatic ligand comprises benzene, toluene, xylene, mesitylene, aniline, ethylbenzene, an alkylbenzene, or styrene.

10. The precursor of claim 1 wherein the ruthenium complex comprises Ru(benzene)(1,4-cyclohexadiene), Ru(benzene)(1-methyl-1,3-cyclohexadiene), Ru(benzene)(2-methyl-1,3-cyclohexadiene), Ru(benzene)(5-methyl-1,3-cyclohexadiene), Ru(benzene)(1-methyl-1,4-cyclohexadiene), Ru(benzene)(3-methyl-1,4-cyclohexadiene), Ru(toluene)(1,3-cyclohexadiene), Ru(toluene)(1-methyl-1,3-cyclohexadiene), Ru(toluene)(2-methyl-1,3-cyclohexadiene), Ru(toluene)(5-methyl-1,3-cyclohexadiene), Ru(toluene)(1,4-cyclohexadiene), Ru(toluene)(1-methyl-1,4-cyclohexadiene), Ru(toluene)(3-methyl-1,4-cyclohexadiene), Ru(xylene)(1,3-cyclohexadiene), Ru(xylene)(1-methyl-1,3-cyclohexadiene), Ru(xylene)(2-methyl-1,3-cyclohexadiene), Ru(xylene)(5-methyl-1,3-cyclohexadiene), Ru(xylene)(1,4-cyclohexadiene), Ru(xylene)(1-methyl-1,4-cyclohexadiene), Ru(xylene)(3-methyl-1,4-cyclohexadiene), Ru(mesitylene)(1,3-cyclohexadiene), Ru(mesitylene)(1-methyl-1,3-cyclohexadiene), Ru(mesitylene)(2-methyl-1,3-cyclohexadiene), Ru(mesitylene)(5-methyl-1,3-cyclohexadiene), Ru(mesitylene)(1,4-cyclohexadiene), Ru(mesitylene)(1-methyl-1,4-cyclohexadiene), Ru(mesitylene)(3-methyl-1,4-cyclohexadiene), Ru(benzene)(1-ethyl-1,3-cyclohexadiene), Ru(benzene)(2-ethyl-1,3-cyclohexadiene), Ru(benzene)(5-ethyl-1,3-cyclohexadiene), Ru(benzene)(1-ethyl-1,4-cyclohexadiene), Ru(benzene)(3-ethyl-1,4-cyclohexadiene), Ru(toluene)(1-ethyl-1,3-cyclohexadiene), Ru(toluene)(2-ethyl-1,3-cyclohexadiene), Ru(toluene)(5-ethyl-1,3-cyclohexadiene), Ru(toluene)(1-ethyl-1,4-cyclohexadiene), Ru(toluene)(3-ethyl-1,4-cyclohexadiene), Ru(xylene)(1-ethyl-1,3-cyclohexadiene), Ru(xylene)(2-ethyl-1,3-cyclohexadiene), Ru(xylene)(5-ethyl-1,3-cyclohexadiene), Ru(xylene)(1-ethyl-1,4-cyclohexadiene), Ru(xylene)(3-ethyl-1,4-cyclohexadiene), Ru(mesitylene)(1-ethyl-1,3-cyclohexadiene), Ru(mesitylene)(2-ethyl-1,3-cyclohexadiene), Ru(mesitylene)(5-ethyl-1,3-cyclohexadiene), Ru(mesitylene)(1-ethyl-1,4-cyclohexadiene), Ru(mesitylene)(3-ethyl-1,4-cyclohexadiene), or combinations thereof.

11. The precursor of claim 1 wherein the ruthenium complex has a melting temperature no more than about 50° C.

12. A method for the deposition of a ruthenium film comprising:
a) placing at least one substrate into a reactor;
b) introducing at least one ruthenium precursor into the reactor, said precursor having the formula:
(L¹)ₓRu(L²)
wherein L¹ comprises a 1,3-cyclohexadiene, a 1,4-cyclohexadiene, or an acyclic alkene, x is an integer ranging from 1 to 2, and L² comprises an aromatic ligand,
wherein if L² comprises an unsubstituted benzene ligand, then L¹ comprises a substituted 1,3-cyclohexadiene, an unsubstituted or substituted 1,4-cyclohexadiene, or a substituted alkene group, and wherein if L² comprises a substituted aromatic ligand, then L¹ comprises a substituted or unsubstituted cyclohexadiene, or a substituted or unsubstituted vinyl group;
c) heating the ruthenium precursor; and
d) depositing the ruthenium film on the substrate.

13. The method of claim 12 wherein the precursor has a melting temperature no more than about 50° C.

14. The method of claim 12 wherein L¹ comprises 1,4-cyclohexadiene, 1-methyl-1,3-cyclohexadiene, 2-methyl-1,3-cyclohexadiene, 5-methyl-1,3-cyclohexadiene, 1-methyl-1,4-cyclohexadiene, 3-methyl-1,4-cyclohexadiene, 1-ethyl-1,3-cyclohexadiene, 2-ethyl-1,3-cyclohexadiene, 5-ethyl-1,3-cyclohexadiene, 1-ethyl-1,4-cyclohexadiene, or 3-ethyl-1,4-cyclohexadiene.

15. The method of claim 12 wherein L¹ comprises an ethylene, a butylene, a propylene, a hexane, a pentene, an olefin, a butadiene, a triene, a diene, or an alkyl butadiene.

16. The method of claim 12 wherein L² comprises benzene, toluene, xylene, mesitylene, aniline, ethylbenzene, an alkylbenzene, or styrene.

17. The method of claim 12 wherein the at least one precursor comprises Ru(benzene)(1,4-cyclohexadiene), Ru(benzene)(1-methyl-1,3-cyclohexadiene), Ru(benzene)(2-methyl-1,3-cyclohexadiene), Ru(benzene)(5-methyl-1,3-cyclohexadiene), Ru(benzene)(1-methyl-1,4-cyclohexadiene), Ru(benzene)(3-methyl-1,4-cyclohexadiene), Ru(toluene)(1,3-cyclohexadiene), Ru(toluene)(1-methyl-1,3-cyclohexadiene), Ru(toluene)(2-methyl-1,3-cyclohexadiene), Ru(toluene)(5-methyl-1,3-cyclohexadiene), Ru(toluene)(1,4-cyclohexadiene), Ru(toluene)(1-methyl-1,4-cyclohexadiene), Ru(toluene)(3-methyl-1,4-cyclohexadiene), Ru(xylene)(1,3-cyclohexadiene), Ru(xylene)(1-methyl-1,3-cyclohexadiene), Ru(xylene)(2-methyl-1,3-cyclohexadiene), Ru(xylene)(5-methyl-1,3-cyclohexadiene), Ru(xylene)(1,4-cyclohexadiene), Ru(xylene)(1-methyl-1,4-cyclohexadiene), Ru(xylene)(3-methyl-1,4-cyclohexadiene), Ru(mesitylene)(1,3-cyclohexadiene), Ru(mesitylene)(1-methyl-1,3-cyclohexadiene), Ru(mesitylene)(2-methyl-1,3-cyclohexadiene), Ru(mesitylene)(5-methyl-1,3-cyclohexadiene), Ru(mesitylene)(1,4-cyclohexadiene), Ru(mesitylene)(1-methyl-1,4-cyclohexadiene), Ru(mesitylene)(3-methyl-1,4-cyclohexadiene), Ru(benzene)(1-ethyl-1,3-cyclohexadiene), Ru(benzene)(2-ethyl-1,3-cyclohexadiene), Ru(benzene)(5-ethyl-1,3-cyclohexadiene), Ru(benzene)(1-ethyl-1,4-cyclohexadiene), Ru(benzene)(3-ethyl-1,4-cyclohexadiene), Ru(toluene)(1-ethyl-1,3-cyclohexadiene), Ru(toluene)(2-ethyl-1,3-cyclohexadiene), Ru(toluene)(5-ethyl-1,3-cyclohexadiene), Ru(toluene)(1-ethyl-1,4-cyclohexadiene), Ru(toluene)(3-ethyl-1,4-cyclohexadiene), Ru(xylene)(1-ethyl-1,3-cyclohexadiene), Ru(xylene)(2-ethyl-1,3-cyclohexadiene), Ru(xylene)(5-ethyl-1,3-cyclohexadiene), Ru(xylene)(1-ethyl-1,4-cyclohexadiene), Ru(xylene)(3-ethyl-1,4-cyclohexadiene), Ru(mesitylene)(1-ethyl-1,3-cyclohexadiene), Ru(mesitylene)(2-ethyl-1,3-cyclohexadiene), Ru(mesitylene)(5-ethyl-1,3-cyclohexadiene), Ru(mesitylene)(1-ethyl-1,4-cyclohexadiene), Ru(mesitylene)(3-ethyl-1,4-cyclohexadiene), or combinations thereof.

18. The method of claim 12 further comprising introducing a co-reactant into the reactor.

19. The method of claim 18 wherein the co-reactant is simultaneously introduced with the at least one ruthenium precursor.

20. The method of claim 18 wherein the co-reactant is sequentially introduced with the at least one ruthenium precursor.

21. The method of claim 18 wherein the co-reactant comprises hydrogen, ammonia, NH₂, NH, or other reductants.

22. The method of claim 12 wherein (b) further comprises introducing a reducing agent or an oxidizing agent into the reactor.

23. The method of claim 22 wherein the reducing agent or the oxidizing agent is simultaneously introduced with the at least one ruthenium precursor.

24. The method of claim 22 wherein the reducing agent or the oxidizing agent is sequentially introduced with the at least one ruthenium precursor.

25. The method of claim 20 comprising continuously introducing the reducing agent or the oxidizing agent into the reactor.

26. The method of claim 20 wherein the reducing agent comprises SiH₄, Si₂H₆, Si₃H₈, or hydrogen-containing radicals.

27. The method of claim 20 wherein the oxidizing agent comprises O₂, O₃, H₂O, H₂O₂, oxygen-containing radicals, an O. radical, an OH. radical, or combinations thereof.

28. The method of claim 12 wherein the reactor is a cold-wall type reactor, a hot-wall type reactor, a single-wafer reactor, a multi-wafers reactors, or any type of deposition system.

29. The method of claim 12 wherein heating the precursor in (b) causes the ruthenium precursor to form a film on the surface of the substrate.
